(19) United States
(12) Patent Application Publication
(10) Pub. No.: US 2013/0236113 A1
(43) Pub. Date: Sep. 12, 2013

(54) IMAGE PROCESSING DEVICE AND IMAGE PROCESSING METHOD

(71) Applicant: SONY CORPORATION, Tokyo (JP)

(72) Inventors: Daisuke TAHARA, Tokyo (JP); Yuji Wada, Tokyo (JP)

(73) Assignee: Sony Corporation, Tokyo (JP)

(21) Appl. No.: 13/748,748

(22) Filed: Jan. 24, 2013

(30) Foreign Application Priority Data
Mar. 7, 2012 (JP) 2012-050436

(51) Int. Cl. G06T 9/00

(52) U.S. Cl. CPC G06T 9/007
USPC 382/248

(57) ABSTRACT

There is provided an image processing device including an inverse transform unit that transforms transform coefficient data of a frequency component of an image including one or more blocks into an image signal by executing an integer inverse discrete wavelet transform, wherein an integer transform function used in the integer inverse discrete wavelet transform has a function graph that is symmetrical about an origin as a reference.

### BACKGROUND

The present disclosure relates to an image processing device and an image processing method.

In many of image encoding schemes that have been put into practice in recent years, the data size of an image is compressed by transforming a digital image signal from a space-domain signal into a frequency-domain signal, and quantizing and encoding data in the frequency domain. For example, in the JPEG (Joint Photographic Experts Group) scheme, a discrete cosine transform (DCT) is used to transform a signal. Meanwhile, in the JPEG 2000 scheme, a discrete wavelet transform (DWT) is used to transform a signal.

Such a transform is typically performed in units of a block that is set in an image. In the DCT, a standing wave (cosine wave) with various frequencies is used in units of a block, while in the DWT, a solitary wave with spatial locality is used in a block. When such a signal transform in units of a block is performed, image distortion (i.e., degradation of the image quality) can occur along a block boundary.

JP 2004-112004A and JP 2001-257596A each disclose a method of, in a DWT-based image encoding scheme, filtering pixels around a block boundary of an image to be decoded, thereby restoring from the degradation of the image quality that has occurred at the block boundary.

### SUMMARY

However, a method of filtering pixels around the block boundary has a side effect that the image is unnaturally blurred in a region around the block boundary. Thus, using an approach of removing a cause of degradation of the image quality would be more advantageous than using an approach of filtering the image in a later stage in that the side effect of the filtering can be avoided.

According to an embodiment of the present disclosure, there is provided an image processing device including an inverse transform unit that transforms transform coefficient data of a frequency component of an image including one or more blocks into an image signal by executing an integer inverse discrete wavelet transform, wherein an integer transform function used in the integer inverse discrete wavelet transform has a function graph that is symmetrical about an origin as a reference.

According to another embodiment of the present disclosure, there is provided an image processing device including a transform unit that transforms an image signal of an image including one or more blocks into transform coefficient data of a frequency component by executing an integer discrete wavelet transform, wherein the integer transform function used in the integer discrete wavelet transform has a function graph that is symmetrical about an origin as a reference.

According to still another embodiment of the present disclosure, there is provided an image processing method for decoding an image including one or more blocks, the method including: transforming transform coefficient data of a frequency component of the image into an image signal by executing an integer inverse discrete wavelet transform, wherein an integer transform function used in the integer inverse discrete wavelet transform has a function graph that is symmetrical about an origin as a reference.

According to the technology of the present disclosure, it is possible to avoid or reduce degradation of the image quality along a block boundary that can occur with the existing method.

### BRIEF DESCRIPTION OF THE DRAWINGS

FIG. 1 is an explanatory diagram illustrating symmetric period expansion at an end of a block;

FIG. 2 is an explanatory diagram showing a function graph of an existing integer transform function in an integer discrete wavelet transform;

FIG. 3A is an explanatory diagram showing a first example of a function graph of a new integer transform function that can be adopted in an embodiment;

FIG. 3B is an explanatory diagram showing a second example of a function graph of a new integer transform function that can be adopted in an embodiment;

FIG. 4 is a block diagram showing an exemplary configuration of an encoder according to an embodiment;

FIG. 5 is an explanatory diagram illustrating a two-dimensional DWT;

FIG. 6 is a block diagram showing an exemplary configuration of a decoder according to an embodiment;

FIG. 7 is a flowchart showing an exemplary flow of an encoding process according to an embodiment; and

FIG. 8 is a flowchart showing an exemplary flow of a decoding process according to an embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be made in the following order.

1. Description of Problems
1.1 Existing Integer Inverse Discrete Wavelet Transform
1.2 New Integer Transform Function

2. Exemplary Configuration of Encoder

3. Exemplary Configuration of Decoder

4. Flow of Encoding Process

5. Flow of Decoding Process

6. Conclusion

### <1. Description of Problems>

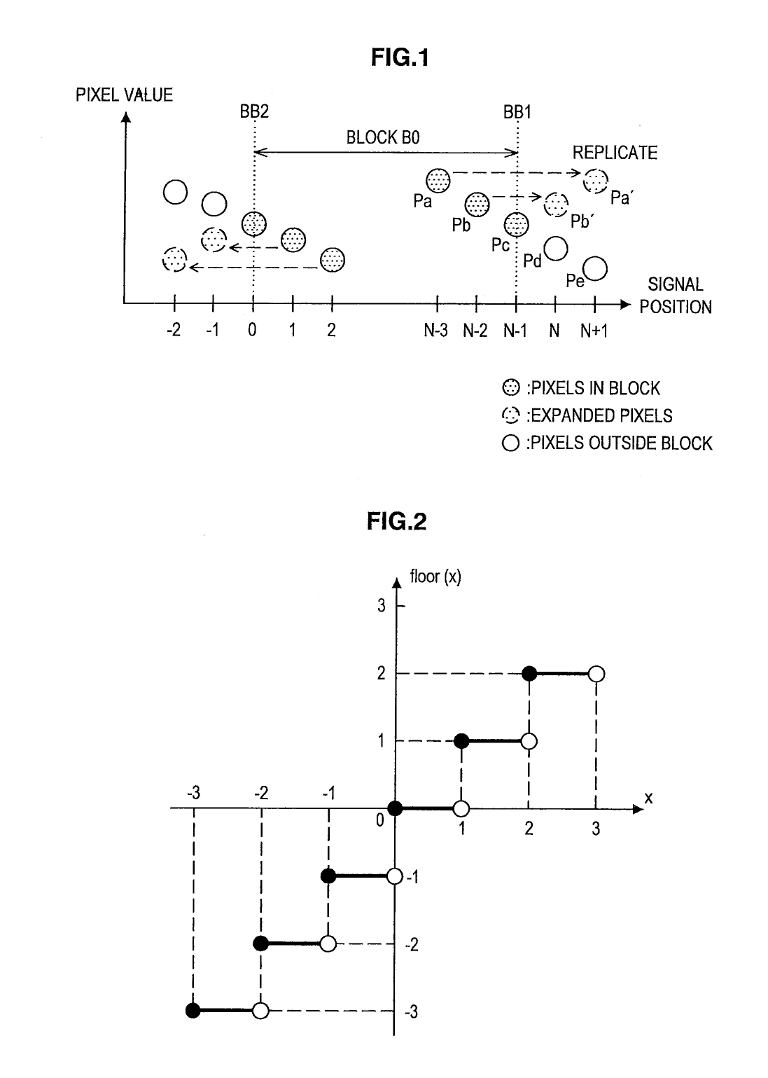

First, problems associated with the technology according to the present disclosure will be described with reference to FIGS. 1 and 2.

### [1-1. Existing Integer Inverse Discrete Wavelet Transform]

A discrete wavelet transform (DWT) adopted in some image encoding schemes such as a JPEG 2000 scheme is substantially realized by a filter computation that uses as input values filter taps including peripheral pixels around each pixel. The DWT come in two types: an integer DWT and a real DWT. Of the two, an integer 5×3 DWT that is one type of the integer DWT is defined as the following Arithmetic Expressions (1) and (2) in the JPEG 2000 scheme, for example.

$$\begin{matrix}Y ( 2 n ) = X ( 2 n ) + floor ( \frac{Y ( 2 n - 1 ) + Y ( 2 n + 1 ) + 2}{4} ) & ( 1 ) \\ Y ( 2 n + 1 ) = X ( 2 n + 1 ) - floor ( \frac{X ( 2 n ) + X ( 2 n + 2 )}{2} ) & ( 2 )\end{matrix}$$

Arithmetic Expression (1) corresponds to a filter computation of a low-pass filter, and Arithmetic Expression (2) corresponds to a filter computation of a high-pass filter. In such arithmetic expressions, n denotes the signal position in the horizontal direction or the vertical direction, X(n) denotes the pixel value at the signal position n, and Y(n) denotes a transform coefficient at the signal position n. Floor(x) is a function that transforms an argument x into an integer by rounding off the decimal part of the argument x. When filter computations of a low-pass filter and a high-pass filter are alternately executed according to Arithmetic Expressions (1) and (2), respectively, for each signal position, the space-domain image signal is transformed into transform coefficient data of a plurality of sub-bands in the frequency domain.

Meanwhile, an integer 5×3 inverse DWT is defined as the following Arithmetic Expression (3) and Arithmetic Expression (4) in the JPEG 2000 scheme, for example.

$$\begin{matrix}X ( 2 n ) = Y ( 2 n ) - floor ( \frac{Y ( 2 n - 1 ) + Y ( 2 n + 1 ) + 2}{4} ) & ( 3 ) \\ X ( 2 n + 1 ) = Y ( 2 n + 1 ) + floor ( \frac{X ( 2 n ) + X ( 2 n + 2 )}{2} ) & ( 4 )\end{matrix}$$

Arithmetic Expression (3) corresponds to a filter computation of a low-pass filter, and Arithmetic Expression (4) corresponds to a filter computation of a high-pass filter. When filter computations of a low-pass filter and a high-pass filter are executed according to Arithmetic Expressions (3) and (4), respectively, transform coefficient data of a plurality of sub-bands in the frequency domain is converted into a space-domain image signal.

When such arithmetic expressions are focused on, it is understood that there is a shortage of filter taps to be input to the filter computations at an end of a block. Therefore, lacking pixel values are supplemented by symmetric period expansion.

FIG. 1 is an explanatory diagram illustrating symmetric period expansion at an end of a block. In FIG. 1, the horizontal axis corresponds to the signal position of a one-dimensionalized image signal, and the vertical axis corresponds to the pixel value at each signal position. A solid circle in FIG. 1 represents the actual pixel value, and a dotted circle represents the pixel value supplemented by symmetric period expansion. In the example in FIG. 1, pixels at positions from the signal position zero to the signal position N−1 are included in a block B0. When an image is encoded with the JPETG 2000 scheme, such a block is called a tile, and a discrete wavelet transform (DWT) is executed on each tile as a processing unit. The size of each tile in the JPETG 2000 scheme is variable. A single tile may be set for the entire image. In that case, an end of the tile is equal to an end of the image. In the example in FIG. 1, pixels Pa, Pb, and Pc are included in the block B0 at positions around a block boundary BB1, while pixels Pd and Pe are not included in the block B0. Thus, for a filter computation of a DWT at the signal position N−1, a pixel Pb′ and a pixel Pa′ are replicated at the signal position N and the signal position N+1, respectively, so that pixel values of the pixels Pa, Pb, Pc, Pb′, and Pa′ are used for the filter computation.

FIG. 2 shows a function graph of the integer transform function floor(x) in Arithmetic Expressions (1) to (4). In Arithmetic Expressions (1) to (4), an argument of the integer transform function has a value obtained by dividing an integer value by 2 or 4. Thus, the decimal part of the argument is any one of zero, 0.25, 0.5, or 0.75. When such decimal part is rounded off by the integer transform function floor(x), a bias in the negative direction is applied to the signal value through the filter computation. For example, results obtained by transforming signal values 0.5, 1.5, and 2.5 into integers are zero, 1, and 2, respectively. Meanwhile, results obtained by transforming signal values −0.5, −1.5, and −2.5 into integers are −1, −2, and −3, respectively. That is, when a positive signal value includes a decimal part, the absolute value of the signal value can decrease through a filter computation, while when a negative signal value includes a decimal part, the absolute value of the signal value can increase through a filter computation.

However, a signal value at an end of a block is not influenced by such a bias due to the aforementioned symmetric period expansion. For example, in an integer 5×3 DWT, provided that the signal position N−1 is an end of a block, a pixel value X(N)=X(N−2) results due to symmetric period expansion. When this is substituted into Arithmetic Expression (2), a transform coefficient Y(N−1)=X(N−1)−X(N−2) is derived. Likewise, in an integer 5×3 inverse DWT, for example, provided that the signal position N−1 is an end of a block, a pixel value X(N)=X(N−2) results due to symmetric period expansion. When this is substituted into Arithmetic Expression (4), a pixel value X(N−1)=Y(N−1)+X(N−2) is derived. That is, in each of the integer 5×3 DWT and the integer 5×3 inverse DWT, an argument of the integer transform function does not include a decimal part due to symmetric period expansion. Thus, as a decimal pat is not substantially rounded off, a specific bias in a particular direction is not applied to the signal value.

Thus, when an image encoded through an integer DWT is decoded, behavior of errors generated through quantization or truncation of a lower bit differs between a block boundary and other portions in the image. Consequently, degradation of the image quality that is visually sensed can occur along the block boundary. In particular, when a single image is divided into a plurality of blocks, the block boundary passes through the center of the image. Thus, distortion along the block boundary can become visually prominent.

In the existing method, when a block distortion appears in a region around a block boundary, recovery from degradation of the image quality is attempted by filtering pixels around the block boundary on the decoder side. Such a method, however, has a side effect that the image is unnaturally blurred in the region around the block boundary. Thus, the technology according to the present disclosure adopts not an approach of performing filtering in a later stage as with the existing method, but an approach of modifying or re-defining an integer transform function that is a cause of degradation of the image quality, with the objective of preventing or reducing degradation of the image quality.

### [1-2. New Integer Transform Function]

In an embodiment of the technology according to the present disclosure, an integer transform function used in arithmetic expressions of an integer DWT and an integer inverse DWT is a function having a function graph that is symmetrical about the origin as a reference. When such an integer transform function is used, it is possible to avoid a circumstance in which, even when a signal value includes a decimal part, a bias is applied to the signal value in a particular direction. The integer transform function may be a function that transforms the absolute value of an argument into an integer independently of the sign of the argument and assigns to the absolute value transformed into the integer the same sign as the sign of the argument.

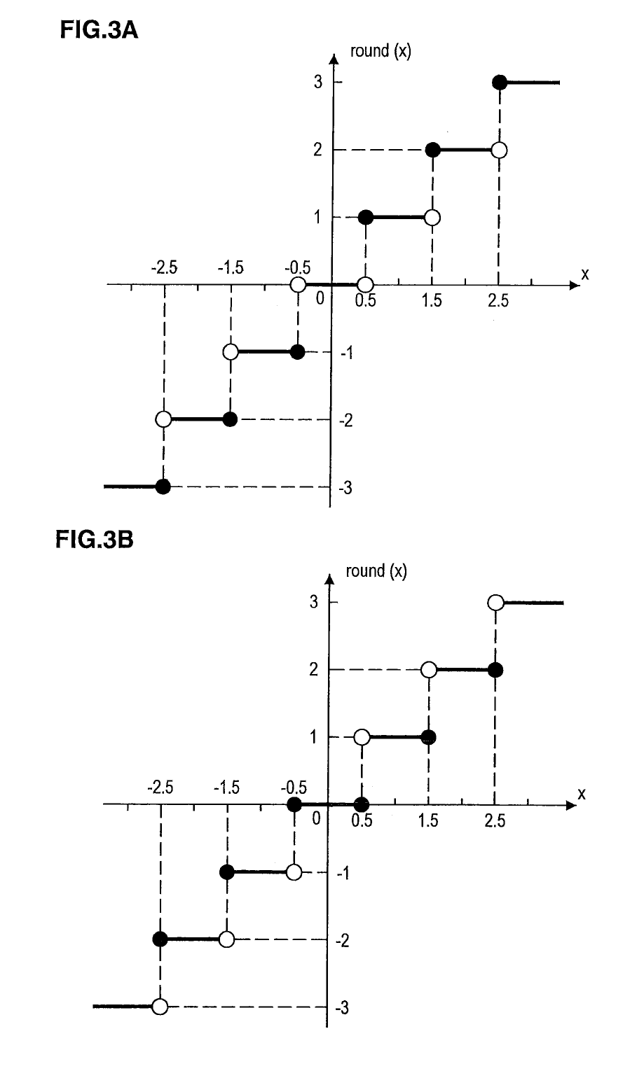

FIGS. 3A and 3B each show an example of a function graph of a new integer transform function that can be adopted in an embodiment. In the example in

FIG. 3A, an integer transform function round(x) is a function that rounds off the absolute value of an argument x to the nearest whole number, thereby assigning to the absolute value transformed into the integer the same sign as the sign of the argument x. For example, results obtained by transforming signal values of 0.5, 1.5, and 2.5 into integers using the integer transform function round(x) in FIG. 3A are 1, 2, and 3, respectively, while results obtained by transforming signal values of −0.5, −1.5, and −2.5 into integers using the integer transform function round(x) are −1, −2, and −3, respectively. In the example in FIG. 3B, the output of the integer transform function round(x) differs from that in the example in FIG. 3A only when the decimal part of the argument x is equal to 0.5. In each of FIGS. 3A and 3B, the behavior of the absolute value of the signal value is independent of whether the signal value is positive or negative.

Note that the integer transform functions shown in FIGS. 3A and 3B are only exemplary, and it is also possible to use another integer transform function having a function graph that is symmetrical about the origin as a reference. In addition, the “symmetricity” herein may be realized in a discrete domain that can be taken by at least the argument of the integer transform function (integral multiples of 0.25 in the examples of Arithmetic Expressions (1) to (4)). Further, although the JPEG 2000 scheme will be mainly described as an example in this specification, the technology according to the present disclosure is not limited thereto, and can be widely applied to various image encoding schemes that are based on an integer DWT and involve symmetric period expansion.

### <2. Exemplary Configuration of Encoder>

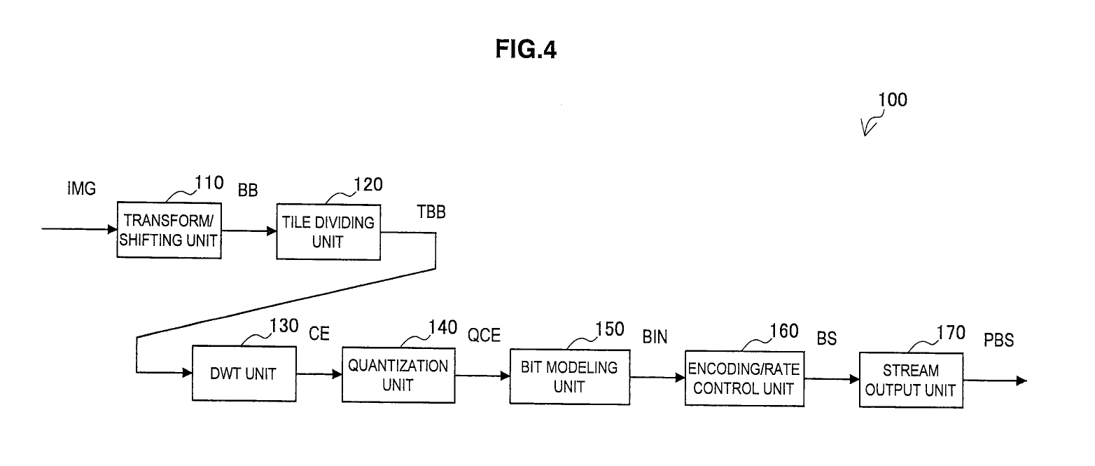

FIG. 4 is a block diagram showing an exemplary configuration of an encoder 100 according to an embodiment. Referring to FIG. 4, the encoder 100 includes a transform/shifting unit 110, a tile dividing unit 120, a DWT unit 130, a quantization unit 140, a bit modeling unit 150, an encoding/rate control unit 160, and a stream output unit 170.

### (1) Transform/Shifting Unit

The transform/shifting unit 110 receives an image signal IMG of an input image. The transform/shifting unit 110, when a color space supported by the encoder 100 differs from a color space of the image signal IMG, transforms the color space of the image signal IMG into the color space supported by the encoder 100.

In addition, the transform/shifting unit 110 uniformly shifts the signal level of the image signal IMG so that the center value of the domain of the signal value of the image signal IMG becomes equal to zero. For example, when the domain of the signal value before shifting is 0 to 255, the signal value can be uniformly subtracted by 128. Then, the transform/shifting unit 110 outputs an image signal BB after the transform and shifting to the tile dividing unit 120.

### (2) Tile Dividing Unit

The tile dividing unit 120 sets one or more tiles in an input image. The size of each tile can be selected from candidates of a plurality of sizes that are equal to the number of pixels, the length of a single side of which is a power of 2. A single tile may also be set in the entire input image. The tile dividing unit 120, in accordance with the setting of tiles, divides the image signal BB into tile signals TBB that are image signals for the respective tiles, and sequentially outputs the tile signals TBB to the DWT unit 130.

### (3) Discrete Wavelet Transform (DWT) Unit

The DWT unit 130 executes a two-dimensional integer DWT on the tile signal TBB input per tile from the tile dividing unit 120, thereby generating transform coefficient data for each tile. Arithmetic expressions of the integer DWT herein may be, for example, Arithmetic Expressions (5) and (6) below.

$$\begin{matrix}Y ( 2 n ) = X ( 2 n ) + round ( \frac{Y ( 2 n - 1 ) + Y ( 2 n + 1 )}{4} ) & ( 5 ) \\ Y ( 2 n + 1 ) = X ( 2 n + 1 ) - round ( \frac{X ( 2 n ) + X ( 2 n + 2 )}{2} ) & ( 6 )\end{matrix}$$

Note that Arithmetic Expression (5) corresponds to a filter computation of a low-pass filter, and Arithmetic Expression (6) corresponds to a filter computation of a high-pass filter. Round(x) denotes an integer transform function for transforming an argument x into an integer and having a function graph that is symmetrical about the origin as a reference. The integer transform function round(x), independently of the sign of an argument x, transforms the absolute value of the argument x into an integer, and assigns to the absolute value transformed into the integer the same sign as the sign of the argument x. The function graph of the integer transform function round(x) may be a graph such as the one shown in FIG. 3A, for example. In that case, the integer transform function round(x) rounds off the absolute value of the argument x to the nearest whole number, thereby transforming the absolute value into an integer. Alternatively, the function graph of the integer transform function round(x) may be a graph such as the one shown in FIG. 3B or another graph that is symmetrical about the origin as a reference. The DWT unit 130, by alternately executing filter computations of a low-pass filter and a high-pass filter in accordance with Arithmetic Expressions (5) and (6), respectively, for each signal position, decomposes the tile signal TBB into two sub-band signals.

When DWT is executed as described above, a shortage of filter taps to be substituted into Arithmetic Expression (5) or (6) occurs at an end of a tile. Thus, the DWT unit 130 executes a filter computation after expanding the pixel value at an end portion of each tile through symmetric period expansion described with reference to FIG. 1.

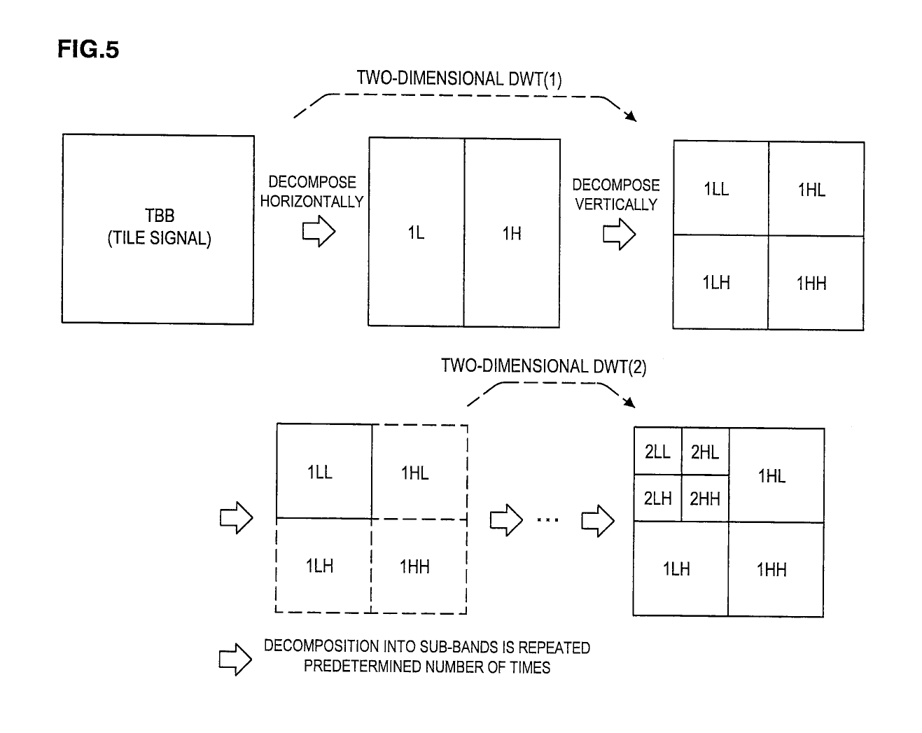

FIG. 5 is an explanatory diagram illustrating a two-dimensional DWT. The upper left view in FIG. 5 shows a tile signal TBB for a single tile. The DWT unit 130 first scans a tile signal TBB in the horizontal direction, and alternately applies a low-pass filter and a high-pass filter for each signal position. The DWT unit 130 rearranges an output signal (1L) of the low-pass filter and an output signal (1H) of the high-pass filter as shown in the upper center view in FIG. 5. When such a process is also executed in the vertical direction, four sub-band signals (1LL, 1HL, 1LH, and 1HH) are obtained as shown in the upper right view in FIG. 5. These are the results of a single two-dimensional DWT. The DWT unit 130 can further execute a two-dimensional DWT on the sub-band signal (1LL) of the low-frequency components. Consequently, as shown in the lower right view in FIG. 5, seven sub-band signals (2LL, 2HL, 2LH, 2HH, 1HL, 1LH, and 1HH) are obtained. The DWT unit 130 repeatedly executes the two-dimensional DWT (decomposition into low-frequency and high-frequency sub-band signals) a predetermined number of times as described above, thereby generating transform coefficient data CE including the transform coefficients of the plurality of frequency components (i.e., sub-bands). Through such hierarchical decomposition into sub-bands, progressive image decoding becomes possible. Note that the decomposition into sub-bands may be repeated any number of times.

The DWT unit 130 outputs to the quantization unit 140 transform coefficient data CE for each tile generated by executing a two-dimensional integer DWT as described above.

### (4) Quantization Unit

The quantization unit 140 quantizes the transform coefficient data CE input from the DWT unit 130, thereby generating quantized transform coefficient data QCE. In the JPEG 2000 scheme, scalar quantization is adopted, and a quantization step can be dynamically determined for each sub-band. The quantization unit 140 outputs the quantized transform coefficient data QCE to the bit modeling unit 150. Note that the quantization process of the quantization unit 140 may be omitted.

(5) Bit Modeling Unit

The bit modeling unit 150 performs bit modeling for realizing EBCOT (Embedded Block Coding with Optimized Truncation) that is a type of entropy encoding. The bit modeling unit 150 generates, for each code block, a bit stream BIN including three encoding passes (sub-bit patterns) from the transform coefficient data QCE input from the quantization unit 140. Then, the bit modeling unit 150 outputs the generated bit stream BIN to the encoding/rate control unit 160.

### (6) Encoding/Rate Control Unit

The encoding/rate control unit 160, in order to achieve a designated encoding rate (or compression rate), determines the bit truncation point (TP) for each code block, and truncates a bit plane of the transform coefficient data QCE corresponding to a lower bit at a position equal to or lower than the truncation point. In addition, the encoding/rate control unit 160 encodes the bit stream BIN of the transform coefficient data including the remaining bit planes using a MQ-Coder that is a type of an arithmetic encoder, thereby generating an encoded stream BS. Then, the encoding/rate control unit 160 outputs the generated encoded stream BS to the stream output unit 170.

### (7) Stream Output Unit

The stream output unit 170 shapes the encoded stream BS input from the encoding/rate control unit 160 into a predetermined file format, thereby generating output data PBS, and then outputs the generated output data PBS. The output data PBS output from the stream output unit 170 may be stored by a storage medium connected to the encoder 100. Alternatively, the output data PBS may be output from the encoder 100 to another device, and be stored or decoded by the other device.

### <3. Exemplary Configuration of Decoder>

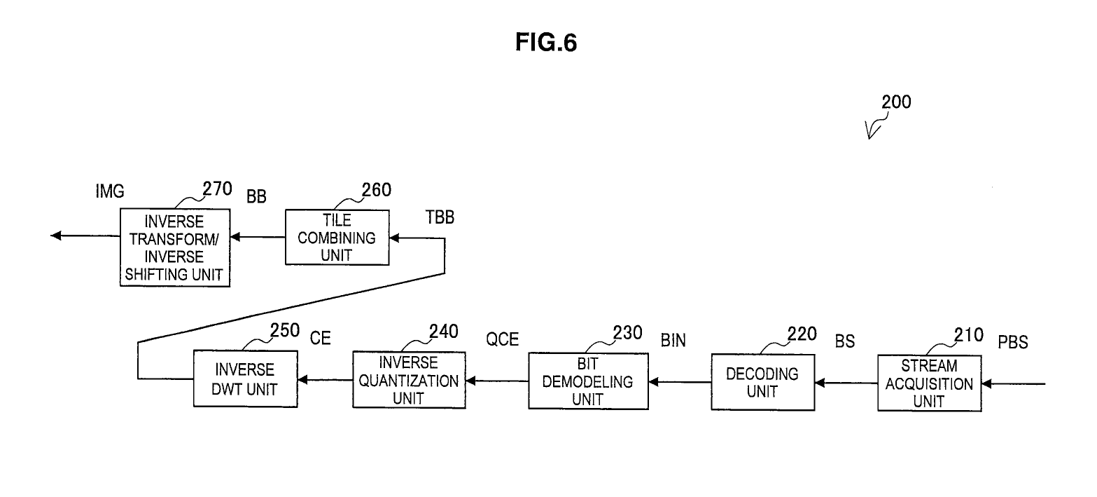

FIG. 6 is a block diagram showing an exemplary configuration of the decoder 200 according to an embodiment. Referring to FIG. 6, the decoder 200 includes a stream acquisition unit 210, a decoding unit 220, a bit demodeling unit 230, an inverse quantization unit 240, an inverse DWT unit 250, a tile combining unit 260, and an inverse transform/inverse shifting unit 270.

### (1) Stream Acquisition Unit

The stream acquisition unit 210 acquires input data PBS that is an input for a decoding process of the decoder 200. The input data PBS includes an encoded stream obtained by encoding transform coefficient data of the frequency components of an image to be decoded. The transform coefficient data is data transformed from an image signal through an integer DWT that involves symmetric period expansion. The file format of the input data PBS may be similar to the format of the output data PBS output from the aforementioned encoder 100, for example. The stream acquisition unit 210 extracts an encoded stream BS from the input data PBS, and outputs the extracted encoded stream BS to the decoding unit 220.

### (2) Decoding Unit

The decoding unit 220 decodes the bit stream BIN of the transform coefficient data from the encoded stream BS input from the stream acquisition unit 210. More specifically, in this embodiment, the decoding unit 220 decodes a bit stream BIN of three encoding passes for each code block from the encoded stream

BS using a MQ-Decoder. Then, the decoder 220 outputs the decoded bit stream BIN to the bit demodeling unit 230.

### (3) Bit Demodeling Unit

The bit demodeling unit 230 rearranges the bit stream BIN input from the decoding unit 220, thereby restoring the transform coefficient data QCE quantized in the encoder 200. Then, the bit demodeling unit 230 outputs the restored transform coefficient data QCE to the inverse quantization unit 240.

### (4) Inverse Quantization Unit

The inverse quantization unit 240 performs inverse quantization on the transform coefficient data QCE input from the bit demodeling unit 230 in a quantization step that is about the same as the step used in the quantization process in the encoder 100, thereby restoring the transform coefficient data CE before quantization. Then, the inverse quantization unit 240 outputs the restored transform coefficient data CE to the inverse DWT unit 250. Note that the inverse quantization process of the inverse quantization unit 240 may be omitted.

### (5) Inverse DWT Unit

The inverse DWT unit 250 executes a two-dimensional integer inverse DWT on the transform coefficient data CE input from the inverse quantization unit 240, thereby restoring a tile signal TBB that is an image signal for each tile. Arithmetic expressions of the integer inverse DWT herein may be Arithmetic Expressions (7) and (8) below, for example.

$$\begin{matrix}X ( 2 n ) = Y ( 2 n ) - round ( \frac{Y ( 2 n - 1 ) + Y ( 2 n + 1 )}{4} ) & ( 7 ) \\ X ( 2 n + 1 ) = Y ( 2 n + 1 ) + round ( \frac{X ( 2 n ) + X ( 2 n + 2 )}{2} ) & ( 8 )\end{matrix}$$

Note that Arithmetic Expression (7) corresponds to a filter computation of a low-pass filter, and Arithmetic Expression (8) corresponds to a filter computation of a high-pass filter. Round(x) denotes an integer transform function for transforming an argument x into an integer and having a function graph that is symmetrical about the origin as a reference. The inverse DWT unit 250 restores tile signals TBB at desired levels by repeating such a two-dimensional integer transform inverse DWT, and sequentially outputs the restored tile signals TBB to the tile combining unit 260.

### (6) Tile Combining Unit

The tile combining unit 260 sequentially arranges the tile signals TBB input from the inverse DWT unit 250 in an image according to the tile position and the tile size, thereby restoring an image signal BB of a single image. Then, the tile combining unit 260 outputs the restored image signal BB to the inverse transform/inverse shifting unit 270.

### (7) Inverse Transform/Inverse Shifting Unit

The inverse transform/inverse shifting unit 270 uniformly shifts the signal value of the image signal BB input from the tile combining unit 260, thereby restoring the image signal IMG. In addition, the inverse transform/inverse shifting unit 270 performs an inverse transform on the color space of the image signal IMG. The image signal IMG restored by the inverse transform/inverse shifting unit 270 may be, for example, output to the display device (not shown) or be stored by a storage medium.

### <4. Flow of Encoding Process>

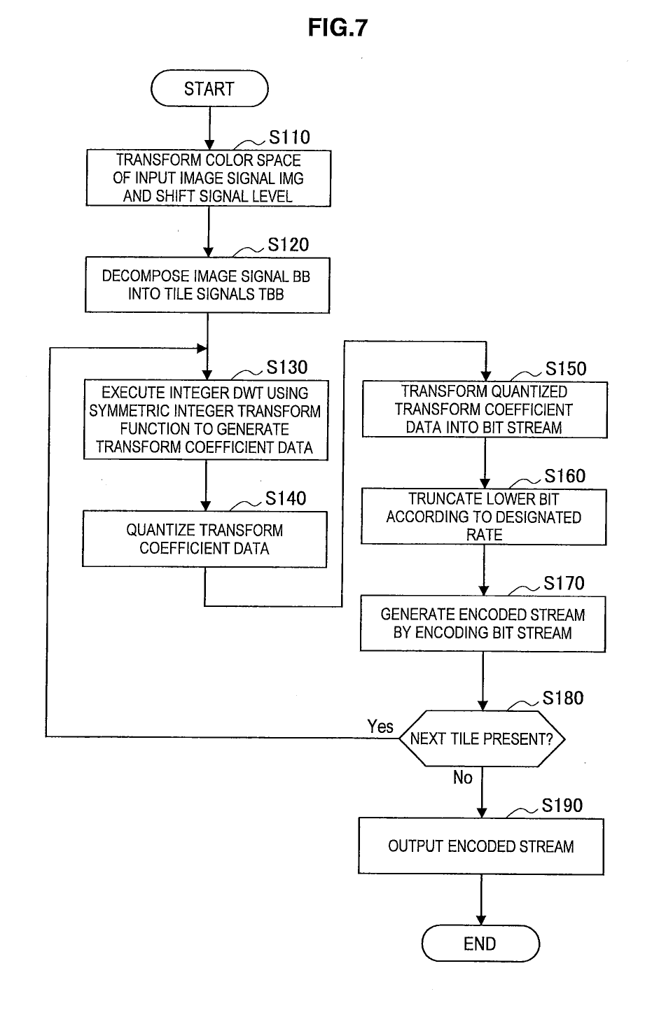

FIG. 7 is a flowchart showing an exemplary flow of an encoding process performed by the encoder 100.

Referring to FIG. 7, first, the transform/shifting unit 110 transforms a color space of an input image signal IMG into a color space supported by the encoder 100, and shifts the signal level (step S110). Then, the transform/shifting unit 110 outputs the image signal BB after transform and shifting to the tile dividing unit 120.

Next, the tile dividing unit 120 sets one or more tiles in the input image and divides the image signal BB into tile signals TBB (step S 120). Then, the tile dividing unit 120 outputs the tile signals TBB to the DWT unit 130. Processes in the following step S130 to step S180 are repeated for each tile in the input image.

The DWT unit 130 executes an integer DWT, which uses an integer transform function having a function graph that is symmetrical about the origin as a reference, on the tile signals TBB input from the tile dividing unit 120, thereby generating transform coefficient data CE (step S130). Then, the DWT unit 130 outputs the generated transform coefficient data CE to the quantization unit 140.

Next, the quantization unit 140 quantizes the transform coefficient data CE input from the DWT unit 130, thereby generating quantized transform coefficient data QCE (step S140). Accordingly, the transform coefficient data can have a quantization error. Then, the quantization unit 140 outputs the quantized transform coefficient data QCE to the bit modeling unit 150.

Next, the bit modeling unit 150 transforms, for each code block, the transform coefficient data QCE input from the quantization unit 140 into a bit stream BIN including three encoding passes (step S150). Then, the bit modeling unit 150 outputs the bit stream BIN to the encoding/rate control unit 160.

Next, the encoding/rate control unit 160 determines the truncation point TP according to a designated encoding rate, and truncates a lower bit at a position equal to or less than the truncation point TP of the bit stream BIN input from the bit modeling unit 150 (step S160). Accordingly, the transform coefficient data can have an error resulting from truncation of the bit.

In addition, the encoding/rate control unit 160 encodes the bit stream BIN whose lower bit has been truncated, thereby generating an encoded stream BS (step S170). Then, the encoding/rate control unit 160 outputs the generated encoded stream BS to the stream output unit 170.

After that, if a next unprocessed tile is present, the process returns to step S130. If encoded streams have been generated for all tiles, the process proceeds to step S190 (step S180).

In step S190, the stream output unit 170 shapes the encoded stream BS into a predetermined file format to generate output data PBS, and outputs the generated output data PBS.

### <5. Flow of Decoding Process>

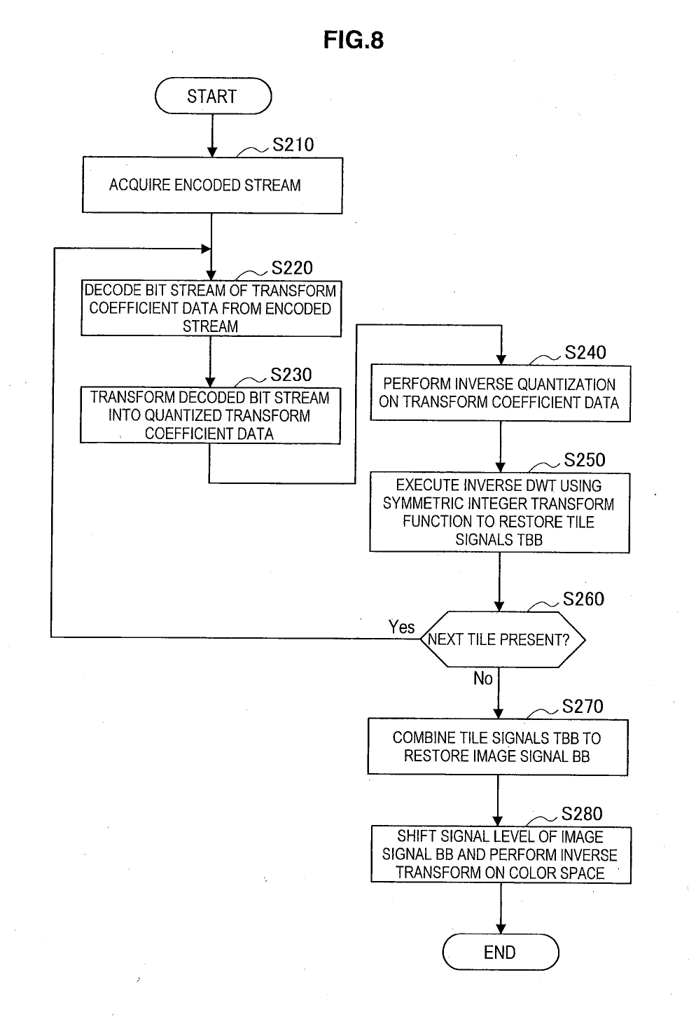

FIG. 8 is a flowchart showing an exemplary flow of a decoding process executed by the decoder 200.

Referring to FIG. 8, first, the stream acquisition unit 210 acquires an encoded stream BS obtained by encoding transform coefficient data of an image to be decoded (step S210). Then, the stream acquisition unit 210 outputs the encoded stream BS to the decoding unit 220.

Processes from the following step S220 to step S260 are repeated for each tile in the input image.

The decoding unit 220 decodes a bit stream BIN of the transform coefficient data from the encoded stream BS input from the stream acquisition unit 210 (step S220). Then, the decoding unit 220 outputs the decoded bit stream BIN to the bit demodeling unit 230.

Next, the bit demodeling unit 230 rearranges the bit stream BIN input from the decoding unit 220, thereby transforming the bit stream BIN to quantized transform coefficient data QCE (step S230). Then, the bit demodeling unit 230 outputs the quantized transform coefficient data QCE to the inverse quantization unit 240.

Next, the inverse quantization unit 240 performs inverse quantization on the transform coefficient data QCE input from the bit demodeling unit 230, thereby restoring the transform coefficient data QCE before quantization (step S240). Then, the inverse quantization unit 240 outputs the restored transform coefficient data CE to the inverse DWT unit 250.

Next, the inverse DWT unit 250 executes a two-dimensional integer inverse DWT, which uses an integer transform function having a function graph that is symmetrical about the origin as a reference, on the transform coefficient data CE, thereby restoring a tile signal TBB that is an image signal for each tile (step S250). Then, the inverse DWT unit 250 outputs the restored tile signals TBB to the tile combining unit 260.

After that, if a next unprocessed tile is present, the process proceeds to step S220. If tile signals TBB for all tiles have been restored, the process proceeds to step S270 (step S260).

In step S270, the tile combining unit 260 combines tile signals TBB of a plurality of tiles input from the inverse DWT unit 250, thereby restoring an image signal BB of a single image (step S270). Then, the tile combining unit 260 outputs the restored image signal BB to the inverse transform/inverse shifting unit 270. Note that when the entire image corresponds to a single tile, the process in step S270 may be skipped.

Next, the inverse transform/shifting unit 270 uniformly shifts the signal value of the image signal BB input from the tile combining unit 260 to restore the image signal IMG, and performs an inverse transform on the color space of the image signal IMG (as needed) (step S280). Then, the inverse transform/inverse shifting unit 270 outputs the image signal IMG to a device connected to the decoder 200 such as a display device or a storage device, for example.

Note that the processes described in this specification need not necessarily be executed in the order shown in the flowchart. For example, the order of the transform of the color space, shifting of the signal level, and tile division may be switched.

### <6. Conclusion>

Heretofore, an embodiment of the technology according to the present disclosure has been described in detail with reference to FIGS. 1 to 8. According to the aforementioned embodiment, in encoding of an image, an integer DWT is executed using an integer transform function having a function graph that is symmetrical about the origin as a reference. Meanwhile, in decoding of an image, an integer inverse DWT is executed using an integer transform function having a function graph that is symmetrical about the origin as a reference. Accordingly, a phenomenon is eliminated in which a bias is applied in a particular direction only to a portion other than a block boundary for an error generated through quantization or truncation of a lower bit. Thus, a phenomenon can be avoided in which degradation of the image quality occurs along the block boundary due to behavior of such an error. In addition, according to the aforementioned embodiment, additional filtering for pixels around the block boundary is not performed. Thus, a side effect that the image is blurred in an area around the block boundary does not occur.

According to the embodiment described above, an integer transform function is a function that transforms the absolute value of an argument of the function into an integer independently of the sign of the argument and assigns to the absolute value transformed into the integer the same sign as the sign of the argument. When such an integer transform function is used, it is avoided that the behavior of the absolute value of a signal value transformed into an integer would differ by being dependent on the sign (positive or negative) of the signal value. Accordingly, behavior of the error becomes uniform between a block boundary where a signal value input to the integer transform function becomes an integer as a result of symmetric period expansion and a non-block boundary where a signal value input to the integer transform function can include a decimal part.

The aforementioned integer transform function may be a function that, by rounding off the absolute value of an argument to the nearest whole number, transforms the absolute value into an integer, for example. The absolute value operation and the round-off operation are already available in a typical image processing environment. Thus, such an integer transform function can be easily implemented at low cost.

Note that the decoder 200 according to the aforementioned embodiment may also be used to decode an image from an encoded stream that has been obtained through an encoding process of the existing encoder, namely, an encoder that executes an integer DWT that uses an integer transform function having a point-asymmetric function graph. In such a case, it is also possible to reduce block distortion for when an image is restored from transform coefficient data including an error through an integer inverse DWT.

The series of the processes of the encoder and the decoder described in this specification may be implemented using any of software, hardware, or a combination of both. A program that constitutes software is stored in advance in a storage medium provided in or outside the device, for example. Then, each program is read by RAM (Random Access Memory) in execution and is executed by a processor such as a CPU (Central Processing Unit), for example.

The technology according to the present disclosure is applicable to various products that encode or decode images such as, for example, a PC (Personal Computer), a smartphone, a PDA (Personal Digital Assistants), a digital camera, a game machine, a content recorder, a content player, or a digital television device.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

Additionally, the present disclosure may also be configured as below.
(1) An image processing device including an inverse transform unit that transforms transform coefficient data of a frequency component of an image including one or more blocks into an image signal by executing an integer inverse discrete wavelet transform, wherein

an integer transform function used in the integer inverse discrete wavelet transform has a function graph that is symmetrical about an origin as a reference.
(2) The image processing device according to (1), wherein the integer transform function is a function that transforms an absolute value of an argument into an integer independently of a sign of the argument, and assigns to the absolute value transformed into the integer the same sign as the sign of the argument.
(3) The image processing device according to (2), wherein the integer transform function transforms the absolute value into an integer by rounding off the absolute value to a nearest whole number.
(4) The image processing device according to any one of (1) to (3), wherein the integer inverse discrete wavelet transform is, provided that an n-th pixel value is X(n) and an n-th transform coefficient is Y(n),
   defined as follows for a low-frequency component,

$$X ( 2 n ) = Y ( 2 n ) - round ( \frac{Y ( 2 n - 1 ) + Y ( 2 n + 1 )}{4} )$$

and defined as follows for a high-frequency component,

$$X ( 2 n + 1 ) = Y ( 2 n + 1 ) + round ( \frac{X ( 2 n ) + X ( 2 n + 2 )}{2} )$$

, where round( )represents the integer transform function.
(5) The image processing device according to any one of (1) to (4), wherein the transform coefficient data is generated in encoding of the image by expanding a pixel value at an end of each block through symmetric period expansion and executing a discrete wavelet transform on the expanded pixel value.
(6) The image processing device according to any one of (1) to (5), wherein

the image processing device is a device that decodes the image according to a JPEG 2000 scheme, and

the block corresponds to a tile.
(7) An image processing device including a transform unit that transforms an image signal of an image including one or more blocks into transform coefficient data of a frequency component by executing an integer discrete wavelet transform, wherein

the integer transform function used in the integer discrete wavelet transform has a function graph that is symmetrical about an origin as a reference.
(8) The image processing device according to (7), wherein the integer transform function is a function that transforms an absolute value of an argument into an integer independently of a sign of the argument and assigns to the absolute value transformed into the integer the same sign as a sign of the argument.
(9) The image processing device according to (8), wherein the integer transform function transforms the absolute value into an integer by rounding off the absolute value to a nearest whole number.
(10) The image processing device according to any one of (7) to (9), wherein the integer discrete wavelet transform is, provided that an n-th pixel value is X(n) and an n-th transform coefficient is Y(n),
   defined as follows for a low-frequency component,

$$Y ( 2 n ) = X ( 2 n ) + round ( \frac{Y ( 2 n - 1 ) + Y ( 2 n + 1 )}{4} )$$

and defined as follows for a high-frequency component,

$$Y ( 2 n + 1 ) = X ( 2 n + 1 ) - round ( \frac{X ( 2 n ) + X ( 2 n + 2 )}{2} )$$

, where round( )represents the integer transform function.
(11) The image processing device according to any one of (7) to (10), wherein the transform unit expands a pixel value at an end of each block through symmetric period expansion and executes a discrete wavelet transform on the expanded pixel value.
(12) The image processing device according to any one of (7) to (11), wherein the image processing device is a device that encodes the image according to a JPEG 2000 scheme, and

the block corresponds to a tile.
(13) An image processing method for decoding an image including one or more blocks, the method including:

transforming transform coefficient data of a frequency component of the image into an image signal by executing an integer inverse discrete wavelet transform, wherein

an integer transform function used in the integer inverse discrete wavelet transform has a function graph that is symmetrical about an origin as a reference.
(14) An image processing method for encoding an image including one or more blocks, the method including:

transforming an image signal of the image into transform coefficient data of a frequency component by executing an integer discrete wavelet transform, wherein

an integer transform function used in the integer discrete wavelet transform has a function graph that is symmetrical about an origin as a reference.
(15) A program for causing a computer that controls an image processing device to function as an inverse transform unit that transforms transform coefficient data of a frequency component of an image including one or more blocks into an image signal by executing an integer inverse discrete wavelet transform, wherein

an integer transform function used in the integer inverse discrete wavelet transform has a function graph that is symmetrical about an origin as a reference.
(16) A program for causing a computer that controls an image processing device to function as a transform unit that transforms an image signal of an image including one or more blocks into transform coefficient data of a frequency component by executing an integer discrete wavelet transform, wherein

an integer transform function used in the integer discrete wavelet transform has a function graph that is symmetrical about an origin as a reference.

The present disclosure contains subject matter related to that disclosed in Japanese Priority Patent Application JP 2012-050436 filed in the Japan Patent Office on Mar. 7, 2012, the entire content of which is hereby incorporated by reference.

What is claimed is:

1. An image processing device comprising an inverse transform unit that transforms transform coefficient data of a frequency component of an image including one or more blocks into an image signal by executing an integer inverse discrete wavelet transform, wherein
an integer transform function used in the integer inverse discrete wavelet transform has a function graph that is symmetrical about an origin as a reference.

2. The image processing device according to claim 1, wherein the integer transform function is a function that transforms an absolute value of an argument into an integer independently of a sign of the argument, and assigns to the absolute value transformed into the integer the same sign as the sign of the argument.

3. The image processing device according to claim 2, wherein the integer transform function transforms the absolute value into an integer by rounding off the absolute value to a nearest whole number.

4. The image processing device according to claim 1, wherein the integer inverse discrete wavelet transform is, provided that an n-th pixel value is X(n) and an n-th transform coefficient is Y(n),
defined as follows for a low-frequency component,
$$X ( 2 n ) = Y ( 2 n ) - round ( \frac{Y ( 2 n - 1 ) + Y ( 2 n + 1 )}{4} )$$
and defined as follows for a high-frequency component,
$$X ( 2 n + 1 ) = Y ( 2 n + 1 ) + round ( \frac{X ( 2 n ) + X ( 2 n + 2 )}{2} )$$
, where round( )represents the integer transform function.

5. The image processing device according to claim 1, wherein the transform coefficient data is generated in encoding of the image by expanding a pixel value at an end of each block through symmetric period expansion and executing a discrete wavelet transform on the expanded pixel value.

6. The image processing device according to claim 1, wherein
the image processing device is a device that decodes the image according to a JPEG 2000 scheme, and
the block corresponds to a tile.

7. An image processing device comprising a transform unit that transforms an image signal of an image including one or more blocks into transform coefficient data of a frequency component by executing an integer discrete wavelet transform, wherein
the integer transform function used in the integer discrete wavelet transform has a function graph that is symmetrical about an origin as a reference.

8. The image processing device according to claim 7, wherein the integer transform function is a function that transforms an absolute value of an argument into an integer independently of a sign of the argument and assigns to the absolute value transformed into the integer the same sign as a sign of the argument.

9. The image processing device according to claim 8, wherein the integer transform function transforms the absolute value into an integer by rounding off the absolute value to a nearest whole number.

10. The image processing device according to claim 7, wherein the integer discrete wavelet transform is, provided that an n-th pixel value is X(n) and an n-th transform coefficient is Y(n),
defined as follows for a low-frequency component,
$$Y ( 2 n ) = X ( 2 n ) + round ( \frac{Y ( 2 n - 1 ) + Y ( 2 n + 1 )}{4} )$$
and defined as follows for a high-frequency component,
$$Y ( 2 n + 1 ) = X ( 2 n + 1 ) - round ( \frac{X ( 2 n ) + X ( 2 n + 2 )}{2} )$$
, where round( ) represents the integer transform function.

11. The image processing device according to claim 7, wherein the transform unit expands a pixel value at an end of each block through symmetric period expansion and executes a discrete wavelet transform on the expanded pixel value.

12. The image processing device according to claim 7, wherein
the image processing device is a device that encodes the image according to a JPEG 2000 scheme, and
the block corresponds to a tile.

13. An image processing method for decoding an image including one or more blocks, the method comprising:
transforming transform coefficient data of a frequency component of the image into an image signal by executing an integer inverse discrete wavelet transform, wherein
an integer transform function used in the integer inverse discrete wavelet transform has a function graph that is symmetrical about an origin as a reference.
